(19) United States
(12) Patent Application Publication
(10) Pub. No.: US 2008/0135657 A1
(43) Pub. Date: Jun. 12, 2008

(54) Shredder blade shaft with an embossed pattern

(75) Inventor: Tie Chun Wang, SanChung City (TW)

Correspondence Address: BACON & THOMAS, PLLC, 625 SLATERS LANE, FOURTH FLOOR, ALEXANDRIA, VA, 22314, US

(73) Assignee: Michilin Prosperity Co., Ltd., SanChung City (TW)

(21) Appl. No.: 11/797,398

(22) Filed: May 3, 2007

(30) Foreign Application Priority Data
Dec. 11, 2006 (TW) 095221780

(51) Int. Cl. B02C 18/16

(52) U.S. Cl. 241/236

(57) ABSTRACT

A shredder blade shaft with an embossed pattern is disclosed. The circumference of its first blade shaft is embossed with a pattern or text. The circumference of its second blade shaft opposite to the first blade shaft is embossed with a meshed pattern. When paper passes through the tightly touched blade shafts that rotate in opposite directions to each other, it is embossed with the same pattern or text as on the circumference of the first blade shaft.

### BACKGROUND OF THE INVENTION

1. Field of Invention

The invention relates to a shredder and, in particular, to a shredder blade shaft with an embossed pattern.

2. Related Art

As is well known, the action principle of a shredder for shredding paper is to dispose several cutting blades on two rotary shafts with spacers in between. A motor and a gear box are employed to drive the two parallel rotary shafts that rotate in opposite directions. They provide a shearing force on passing paper to cut it into small stripes. According to the mechanical cutting type, shredders can be classified as stripe-cut shredders and cross-cut shredders. In the former case, the cutting blades are disposed regularly on the rotary shafts and cut the paper along the longitudinal direction into long stripes. Each blade in the latter case has several hook-shaped cutting edges. The blades are disposed in a spiral way on the rotary shafts. In this case, the paper is not only cut along the longitudinal direction into stripes, but also cut in the transverse direction into chips.

As shown in FIGS. 1 and 2, the traditional blades are made of metal plates. They are then mechanically forged into circular blades using tools. The center of the blade is formed with a polygonal hole A1 for the rotary shaft to go through. The circumference of the blade is formed with a hook-shaped cutting edge A2 every 120 degrees. When two blades mounted on the rotary shaft S are combined into a blade set A in a back-to-back way, as shown in the drawing, then the hook-shaped cutting edges of the two blades form an approximately V-shaped opening A3. The opposite rotary shaft S′ separates the two blades using a spacer (not shown) and forms another blade set A′ in a face-to-face way. When paper goes through the oppositely rotating shafts S, S′, the relative rotations of the so-called blade spans A4 cut the paper as scissors do. Afterwards, the relative motions of the hook-shaped cutting edges A2 and the opposite blade spans A4 further cut the paper stripes in the horizontal direction into small pieces.

According to the above-described paper shredding process, the blades and the spacers disposed on the rotary shafts cost a lot in the materials and human assembly. Therefore, it is not suitable for the competitive market. Besides, the shredded paper pieces look the same in all the traditional shredders. This cannot satisfy the need of novelty by the consumers.

### SUMMARY OF THE INVENTION

In view of the foregoing, the invention provides a shredder blade shaft with an embossed pattern to solve the above-mentioned problems.

An objective of the invention is to provide a shredder blade shaft with an embossed pattern. The circumference of the first blade shaft is embossed with a pattern of text. The circumference of the second blade shaft opposite to the first blade shaft is embossed with a meshed pattern. When paper passes through the tightly touched blade shafts that rotate in opposite directions to each other, the embossed pattern or text on the circumference of the first blade shaft destroys the paper. The remained part of the paper has the shame pattern or text as the one on the first blade shaft.

Another objective of the invention is to provide a shredder blade shaft with an embossed pattern that does not need the conventional blades and spacers in order to save the overall production cost by reducing the material and human assembly costs.

Yet another objective of the invention is to provide a shredder blade shaft with an embossed pattern that produces shredded paper with the same pattern thereon. It provides additional joy that cannot be obtained from traditional shredders. The pattern or text can be trademarks to promote or advertise business.

To achieve the above objectives, the disclosed shredder blade shaft with an embossed pattern has an embossed pattern or text integrally formed on the circumference of its first blade shaft and a meshed pattern formed on the circumference of the second blade shaft opposite to the first blade shaft. When paper passes through the tightly touched blade shafts that rotate in opposite directions to each other, the shredded paper is embossed with the pattern or text on the circumference of the first blade shaft.

### BRIEF DESCRIPTION OF THE DRAWINGS

The invention will become more fully understood from the detailed description given herein below illustration only, and thus is not limitative of the present invention, and wherein:

FIG. 1 is a three-dimensional view of the blade set in a conventional shredder;

FIG. 2 shows the action of the blades in a conventional shredder;

FIG. 3 is a front view of the first blade shaft of the invention;

FIG. 4 is a front view of the second blade shaft of the invention; and

FIG. 5 is an expanded view of the first blade shaft of the invention.

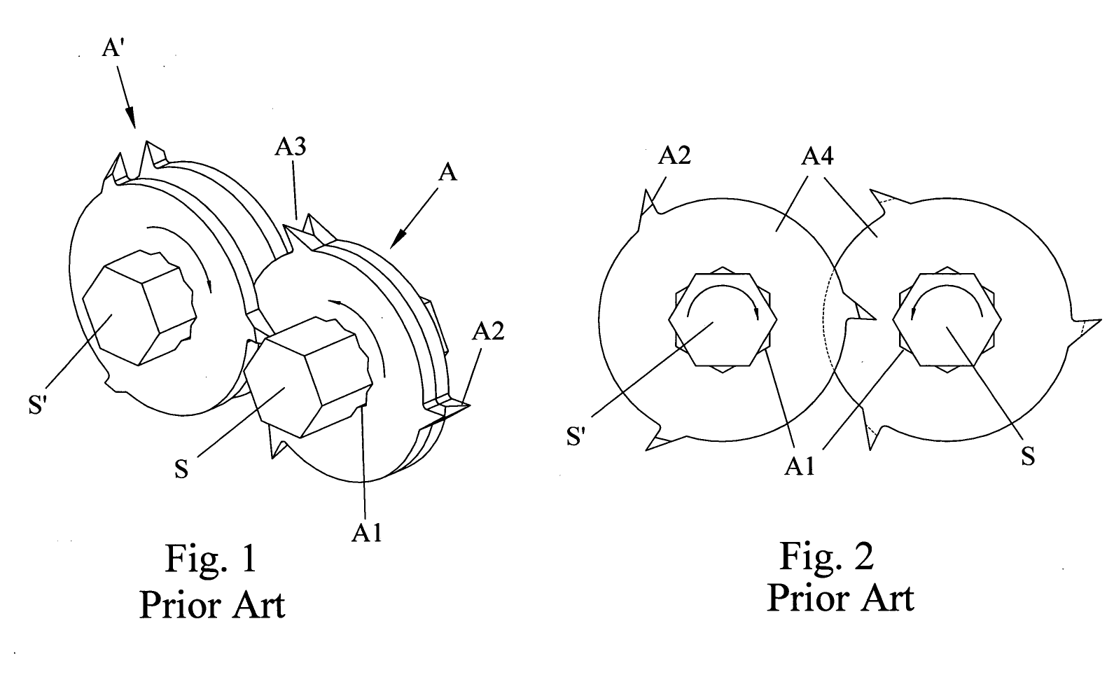

### DETAILED DESCRIPTION OF THE INVENTION

The present invention will be apparent from the following detailed description, which proceeds with reference to the accompanying drawings, wherein the same references relate to the same elements.

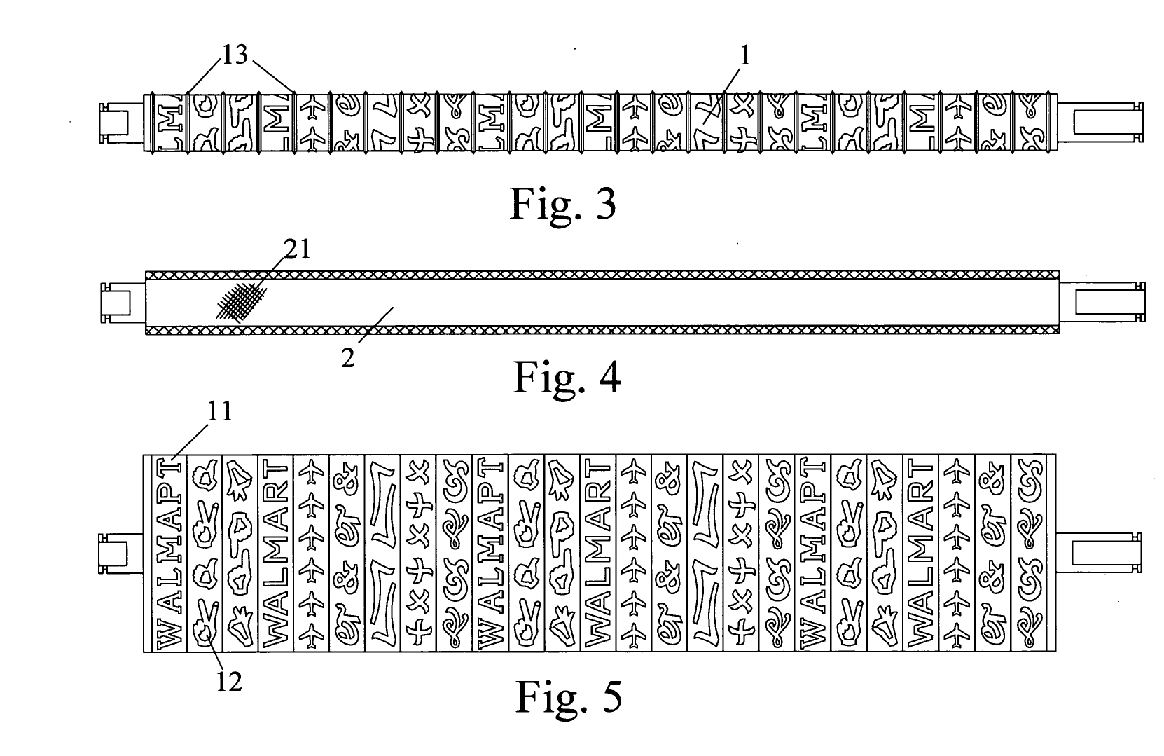

Please refer to FIGS. 3 to 5. FIGS. 3 and 5 are the front view and the expanded view of the first blade shaft of the invention. FIG. 4 is a front view of the second blade shaft of the invention.

The above-mentioned drawings disclose a set of revolutionary blade shafts for a shredder. The circumference of the first blade shaft 1 is formed with an embossed pattern or text. As shown in FIG. 5, the embossed text on the first row is the trademark 11 of a famous chain store, WALMART, and the second row is a finger pattern 12. The first row 11 and the second row 12 are separated by a cutting edge protruding from the first blade shaft. FIG. 4 shows that the circumference of the second blade shaft 2 is embossed with a meshed pattern 21.

When the first blade shaft and the second blade shaft are in tight contact and rotate in opposite directions to each other, paper passing through it is cut into striped by the cutting edge 13. Each of the stripes is embossed with the corresponding pattern. This does not only destroy the paper and make it difficult to recover the original document, using the trademark of, for example, WALMART can distinguish the product from the shredders from some other chain store such as Office Max (OMX). This can promote and advertise the business.

Moreover, the blades and spacers in the prior art are not used in the invention at all. The reduced material and human assembly costs help saving a lot of production cost. This greatly enhances the competitive power of the products.

In summary, the circumference of the first blade shaft is embossed with a pattern or text, and the circumference of the second blade shaft is embossed with a meshed pattern according to the invention. Such a revolutionary structure effectively reduces the production cost and greatly enhances the competitive power of the products.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A shredder blade shaft assembly with embossed pattern or embossed text formed around the circumference of one of its blade shafts.
